(19) United States
(12) Patent Application Publication
(10) Pub. No.: US 2016/0295256 A1
(43) Pub. Date: Oct. 6, 2016

(54) DIGITAL CONTENT STREAMING FROM DIGITAL TV BROADCAST

(71) Applicant: Microsoft Technology Licensing, LLC, Redmond, WA (US)

(72) Inventors: Neeraj Sharma, Bothell, WA (US); Yongjun Wu, Bellevue, WA (US); Shyam Sadhwani, Bellevue, WA (US); Matthew Andrews, Redmond, WA (US); Nimesh Amin, Seattle, WA (US); Brian Joseph Ewanchuk, Redmond, WA (US); Stewart Paul Tootill, Bracknell (GB); David Niall Coghlan, London (GB); Michal Mark Vine, London (GB)

(73) Assignee: Microsoft Technology Licensing, LLC, Redmond, WA (US)

(21) Appl. No.: 14/675,479

(22) Filed: Mar. 31, 2015

(51) Int. Cl. H04N 21/236; H04N 21/854; H04N 21/4402; H04N 21/845; H04N 21/2187; H04N 21/61; H04N 21/434

(52) U.S. Cl. CPC H04N 21/23614; H04N 21/6143; H04N 21/6131; H04N 21/85406; H04N 21/4341; H04N 21/845; H04N 21/2187; H04N 21/440218

(57) ABSTRACT

Techniques are described for remuxing multimedia content received in a digital video broadcasting format without performing transcoding of the video and/or audio content. For example, a computing device with a digital television tuner can receive multimedia content in a digital video broadcast format. The computing device can remux the received multimedia content from the digital video broadcasting format in which the multimedia content is received into a target streaming protocol for streaming to other devices. Remuxing operations can comprise demultiplexing the received multimedia content to separate the audio and video content, performing meta-data reconstruction, and multiplexing the audio and video content into a target stream using a target streaming protocol format.

### BACKGROUND

With the switch to digital television for over-the-air broadcasts, users are able to receive and watch high-quality digital television programming using a device (e.g., a television or set-top-box) equipped with a digital television tuner. Watching digital television content on a television equipped with such a tuner, or a set-top-box with a connected television, is a straightforward task.

In some situations the user may want to view the digital television content on another device. However, the process of providing the digital television content to another device may not be possible without significant degradation of the video and audio content as well as significant delays in processing.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are described for remuxing multimedia content received via an over-the-air digital video broadcast signal without performing transcoding (decoding followed by encoding, which can be a resource-intensive and slow process) of the video and/or audio content. For example, a computing device with a digital television tuner can receive multimedia content in a digital video broadcast television signal. The computing device can remux the received multimedia content from the digital video broadcasting format in which the multimedia content is received into a target streaming protocol for streaming to other devices (e.g., to stream the remuxed audio and video content to other computing devices, such as smart phones, tablets, laptops, or other computing devices connected via wired or wireless connections).

As another example, multimedia content, comprising audio and video content can be received via a digital video broadcast television signal in a digital video broadcasting format. A target streaming protocol can be determined. The multimedia content can be demultiplexed to separate the audio content and the video content. Meta-data reconstruction can be performed for the video content based, at least in part, on the target streaming protocol. The video content can be multiplexed in a target stream according to a target streaming protocol using the reconstructed meta-data and without transcoding the video content. The audio content can be multiplexed in the target stream according to the target streaming protocol without transcoding the audio content. The target stream can be provided according to the target streaming protocol for streaming to a target computing device.

In some implementations, the audio coding format of the audio content is checked to determine whether it is compatible with a target computing device or otherwise in a supported format. When the audio coding format is not supported, the audio content is transcoded before being multiplexed into the target stream. When the audio coding format is supported, the audio content is not transcoded before being multiplexed into the target stream. Audio content that is not transcoded may still be remuxed if needed (e.g., with changes in header format).

As described herein, a variety of other features and advantages can be incorporated into the technologies as desired.

### BRIEF DESCRIPTION OF THE DRAWINGS

FIG. 1 is a diagram of an example environment for remuxing multimedia content received via a digital video broadcast signal.

FIG. 2 is a diagram depicting example operations for remuxing multimedia content received via a digital video broadcasting format.

FIG. 3 is a flowchart of an example method for remuxing multimedia content received via a digital video broadcasting format, including separate audio and video content processing.

FIG. 4 is a flowchart of an example method for remuxing multimedia content received via a digital video broadcasting format without transcoding.

FIG. 5 is a diagram of an example computing system in which some described embodiments can be implemented.

FIG. 6 is an example mobile device that can be used in conjunction with the technologies described herein.

FIG. 7 is an example cloud-support environment that can be used in conjunction with the technologies described herein.

### DETAILED DESCRIPTION

### Overview

As described herein, various technologies are provided for remuxing multimedia content received via an over-the-air digital video broadcast signal without performing transcoding of the video and/or audio content. For example, a computing device with a digital television tuner can receive multimedia content in a digital video broadcast television signal. The computing device can remux the received multimedia content from the digital video broadcasting format in which the multimedia content was received into a target streaming protocol for streaming to other devices (e.g., to stream the remuxed audio and video content to other computing devices, such as smart phones, tablets, laptops, or other computing devices connected via wired or wireless connections). Remuxing (or re-multiplexing) refers to the procedure for demultiplexing multimedia content to separate audio and/or video content, processing the audio and/or video content if needed, and multiplexing the audio and/or video content in a new file format and container without any degradation of audio and/or video quality.

For example, the multimedia content can comprise audio and/or video content (e.g., audio and video content for a television program, movie, or other multimedia content). The received multimedia content can be demultiplexed in order to separate the audio and video content. The separated audio and/or video content can then be processed separately. For example, the video content can be processed by performing meta-data reconstruction (e.g., reconstructing meta-data that is missing from the digital video broadcasting format). The video content can then be multiplexed into an output stream according to a selected target streaming protocol (e.g., a target streaming protocol that is supported by a target computing device). The audio content can also be multiplexed into the output stream. In some situations, the audio content is reformatted (e.g., an audio coding header format of the audio content is changed so that the audio content is compatible with the target computing device). In some situations, the audio content is transcoded (e.g., when the audio coding format is not compatible with the target computing device). Example target streaming protocols include HTTP Live Streaming (HLS) and Dynamic Adaptive Streaming over HTTP (DASH, also called MPEG-DASH).

Remuxing from a digital video broadcasting format to a target streaming format can be performed by a computing device, such as a desktop computer, laptop computer, server, set-top box, entertainment device, gaming console, or another type of computing device. In some implementations, the remuxing operations are performed by an entertainment console with a digital television tuner (e.g., attached via a universal serial bus (USB) interface) comprising an antenna for receiving over-the-air digital video broadcast television signals.

The digital video broadcast television signals are received in a digital video broadcasting (DVB) format. The DVB format is a collection of standards for communicating digital television signals, and includes standards for communicating digital video broadcast television signals over-the-air. Over-the-air digital video broadcast television signals can be received by a digital television tuner. A digital television tuner can be an integrated tuner with an antenna (e.g., integrated with a computing device, such as a smart television or set-top-box) or a removable digital television tuner module (e.g., a universal serial bus digital television tuner module with integrated antenna).

Remuxing from a digital video broadcasting format to a target streaming format, instead of performing transcoding, can provide advantages in terms of efficiency. For example, remuxing can be performed more quickly than transcoding (e.g., remuxing can be performed with very limited available computing resources in real-time or near-real-time, such as with a delay of only a few seconds). Remuxing uses fewer computing resources (e.g., processor time and memory) as the video and/or audio does not have to be decoded and re-encoded (as would be done with transcoding). In addition, remuxing results in higher quality than transcoding. For example, with remuxing the original quality of the audio and video content from the digital video broadcast can be retained in the target streaming format.

However, remuxing can be difficult to perform with audio and/or video received in a digital video broadcasting format. For example, meta-data for the audio and/or video content may be missing, incorrect, or incomplete in the digital video broadcasting format. Therefore, the various technologies described herein can be applied to reconstruct meta-data during the remux processing so that the output target stream in the target streaming format contains correctly formatted meta-data for playback on a target computing device. Without meta-data reconstruction, the remuxed audio and/or video content may not play back correctly on the target device with desired target formats (e.g., audio and/or video decoding or display errors may be present, which can result in software crashes, playback or display problems, or corrupted audio and/or video).

### Reconstructing Meta-Data

In the technologies described herein, meta-data can be reconstructed for remuxing video and/or audio content in a target streaming format. Reconstructing meta-data can include determining meta-data that may be missing, or partially missing, for the video and/or audio content (e.g., meta-data that is not present in a digital video broadcasting format in which the audio and/or video content is received). Reconstructing meta-data can include changing existing meta-data that may not be correct (e.g., that may not conform to a target streaming format). Reconstructing meta-data can also include removing meta-data that is not needed (e.g., that may not be needed for a target streaming format or that may not conform to a target streaming format).

In some implementations, presentation timestamp (PTS) values and/or decoding timestamp (DTS) values are calculated during video remux according to a procedure that takes into account the maximum number of reordering pictures and the available PTS values. The procedure is defined by the following operations:

1. At the beginning of the video content, a specific number of pictures is buffered equal to the maximum number of reordering pictures defined in video coding standards, such as H.264/AVC and HEVC/H.265. In some implementations, 16 is the maximum number of reordering pictures and therefore 16 compressed pictures are buffered. The maximum number of reordering pictures can be dependent on the video coding standard used to code the video content (e.g., in H.264/AVC the maximum number of reordering pictures is 16).
2. The minimum PTS value is determined and used as the starting DTS value.
3. The DTS offset is calculated as discussed below.
4. The starting DTS value is adjusted by subtracting the DTS offset, and subsequent DTS values are calculate based on the adjusted starting DTS value. This procedure satisfies the constraint that DTS is always less than or equal to PTS for all samples, which is a requirement for streaming protocol formats such as HLS and DASH, and which if violated may cause problems (e.g., during decoding and/or playback).

The DTS offset is calculated using Equation 1 below, where frame_duration is the duration of one frame and num_reordering is the maximum number of reordering pictures.

DTS offset=minimum PTS in window−(corresponding DTS from same sample as minimum PTS)−frame_duration*num_reordering (Equation 1)

The operation of the DTS calculation can be described with reference to a simplified example. In the simplified example, there are four pictures, as listed in the top row of Table 1 below. The PTS values (determined from the meta-data of the received video content in the digital video broadcasting format) at listed in the second row. From the PTS values, the starting DTS values are determined using the procedure above (the minimum PTS value of 101 is used as the starting DTS value and the remaining starting DTS values are populated). The DTS offset is then calculated as follows: DTS offset=101 (minimum PTS)−101 (corresponding DTS)−1 (frame duration in the simplified example)*4(num_reordering in the simplified example)=−4. The starting DTS value of 101 is then adjusted by subtracting four, resulting in an adjusted starting DTS value of 97, and the remaining adjusted DTS values are calculated from 97, as listed in the fourth row of Table 1 below.

TABLE 1
DTS Calculation for Simplified Example

| | Picture: | | | |
|---|---|---|---|---|
| | I picture | P picture | B picture | B picture |
| PTS values: | 101 | 104 | 102 | 103 |
| Starting DTS values: | 101 | 102 | 103 | 104 |
| Adjusted DTS values: | 97 | 98 | 99 | 100 |

In some implementations, a discontinuity in the video content is detected based on the DTS and/or PTS values. In these implementations, a discontinuity is detected when DTS>PTS−frame_duration. In some implementations, an additional check is performed to determine whether the PTS has jumped too far ahead, which is detected when DTS<PTS−num_reordering*frame_duration. When a discontinuity is detected, the DTS values a recalculated (e.g., as discussed above with regard to Equation 1). A discontinuity can occur, for example, when a television program switches to a commercial, or in general switches between content where timing information changes or is otherwise not continuous.

Additional or other meta-data reconstruction operations can be performed, as described elsewhere herein. For example, meta-data reconstruction can be performed to determine meta-data including timing information (e.g., DTS and/or PTS information), picture type information (e.g., to identify pictures as I pictures, P pictures, B pictures, IDR pictures, etc.), discontinuity information, duration information, and/or frame size information.

### Environment for Remuxing Multimedia Content from Digital Video Broadcasts

In the technologies described herein, an environment can be provided for remuxing multimedia content received via a digital video broadcast. For example, a computing device comprising an antenna for receiving an over-the-air digital video broadcast signal (e.g., via an integrated or add-on digital television tuner) can receive multimedia content in a digital video broadcasting format and remux the audio and/or video in the multimedia content into a different streaming protocol format for transmitting (e.g., via a wired or wireless connection) to other computing devices.

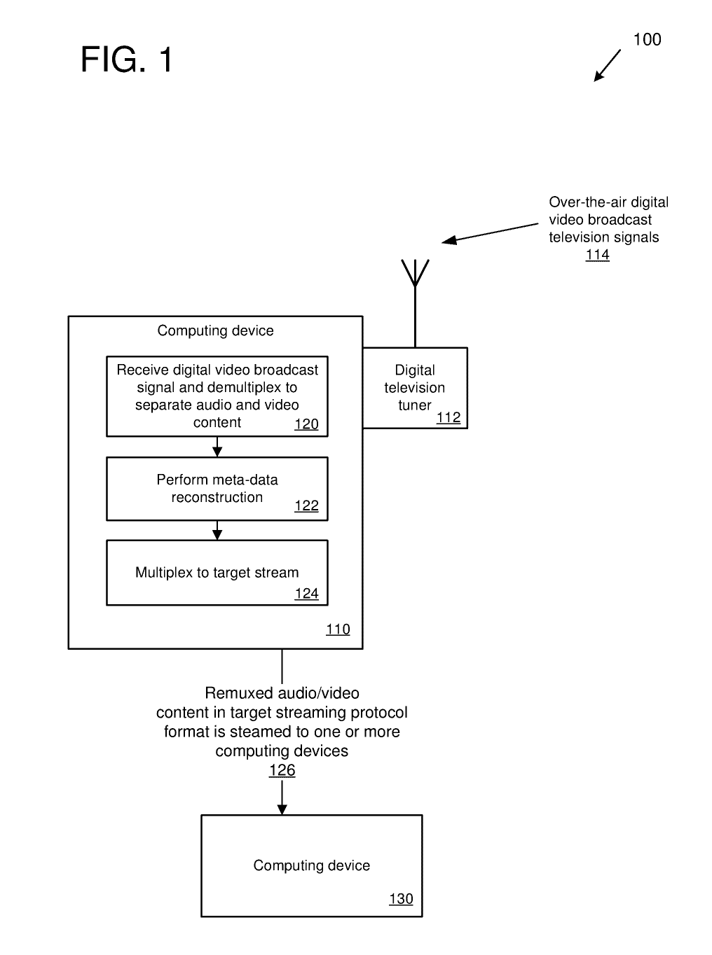

FIG. 1 is a diagram of an example environment 100 in which multimedia content received via a digital video broadcasting signal can be remuxed for streaming to other devices using a target streaming protocol. In the example environment 100, a computing device 110 (e.g., a desktop computer, laptop computer, server, set-top box, entertainment device, gaming console, or another type of computing device) with a digital television tuner 112 (e.g., a built-in digital television tuner or an external digital television tuner such as a USB digital television tuner module) with an antenna is configured to receive digital video broadcast television signals 114 in a digital video broadcasting (DVB) format. Instead of a digital television tuner 112 for receiving over-the-air digital television broadcast signals, reception of digital television in a DVB format can be performed via an integrated or external cable and/or satellite receiver.

The computing device 110 performs a number of operations for remuxing multimedia content received via the digital television tuner 112. In some implementations, the computing device 110 receives multimedia content via a digital video broadcast signal in a digital video broadcasting format and demultiplexes the multimedia content to separate the audio content and the video content, as depicted at 120. The computing device 110 performs meta-data reconstruction for the video content, as depicted at 122. For example, the meta-data reconstruction can involve determining timing information (e.g., PTS and/or DTS timing values) as well as other meta-data information for the video content. Processing can also be performed for the audio content, such as changing audio header information. The video content with the reconstructed meta-data and the audio content are then multiplexed into a target stream according to format defined by a target streaming protocol (e.g., HLS, MPEG-DASH, or another target streaming protocol), as depicted at 124. The target stream can be provided for streaming by the computing device 110 to other computing devices on-the-fly as the remuxing is performed. The target stream can also be saved by the computing device 110 and provided for streaming to other computing devices (e.g., at a later time).

For example, remuxed multimedia content in a target streaming protocol format can be streamed to one or more other computing devices, such as to computing device 130, as depicted at 126. Computing device 130 can be a smart phone, tablet, notebook, or another type of computing device that is connected to computing device 110 via a wireless and/or wired network (e.g., via a wired local area network (LAN), via a Wi-Fi network, etc.). In some implementations, the computing device 130 is configured to perform particular audio processing operations. For example, if the audio content of the target stream is in a format or coding standard not compatible with the computing device 130, the computing device 130 can change the header format and/or perform transcoding of the audio content.

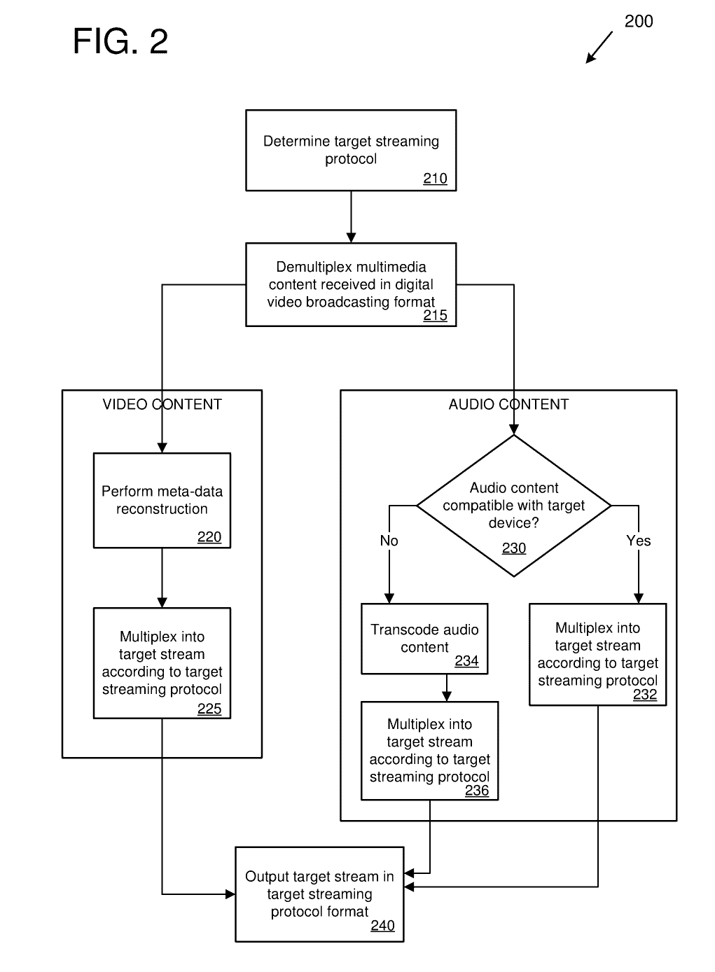

FIG. 2 is a diagram depicting example operations 200 for remuxing multimedia content received via a digital video broadcast signal. At 210, a target streaming protocol is determined for remuxing digital multimedia content received in a digital video broadcasting format. The target streaming protocol can be a predetermined protocol (e.g., the HLS streaming protocol or the DASH streaming protocol) or it can be dynamically determined based on which computing device, or devices, are to be supported (e.g., based on a target computing device to which the remuxed target stream will be communicated).

At 215, the received multimedia content is demuxed to separate the audio content and the video content. The audio content and the video content are processed separately. For the video content, meta-data reconstruction is performed at 220. The meta-data reconstruction can be performed to determine meta-data including timing information (e.g., DTS and/or PTS information), picture type information (e.g., to identify pictures as I pictures, P pictures, B pictures, IDR pictures, etc.), discontinuity information, duration information, and/or frame size information. The video content, with the reconstructed meta-data, is then multiplexed, at 225, into a target stream according to the target stream protocol.

In some implementations, a check is performed, at 230, to determine whether an audio coding format of the audio content is compatible with the target device. For example, some devices may only support audio content in the Advanced Audio Coding (AAC) audio coding standard, while the received audio content may be in the Dolby® Digital (also called AC-3) audio coding standard. If the audio content is not compatible with the target device, the audio content is transcoded at 234 (e.g., from AAC to AC-3). The transcoded audio content is then multiplexed, at 236, into the target stream according to the target streaming protocol. If the audio content is compatible with the target device, then the audio content is multiplexed, at 232, into the target stream according to the target streaming protocol without transcoding being performed. Even though transcoding is not performed if the audio content is compatible with the target device, some change in the audio transport stream format (also called the audio header format) may be performed (e.g., from AAC Low Overhead Audio Transport Multiplex (LATM) to AAC Audio Data Transport Stream (ADTS)) without having to decode and encode the audio content.

In some implementations, the audio is not transcoded, and therefore operations 230, 234 and 236 are not performed.

Once the audio and video content have been multiplexed into the target stream according to the target streaming protocol, the target stream is output at 240. For example, the target stream can be saved in one or more files for later streaming to one or more target computing devices, or the target stream can be provided in real-time for streaming to one or more target computing devices.

### Methods for Multi-Stage Image Classification

In any of the examples herein, methods can be provided for remuxing multimedia content received via digital video broadcast television signals. For example, received multimedia content in a digital video broadcasting format can be remuxed to a target stream according to a target streaming protocol (e.g., HLS, DASH, or another streaming protocol) without performing transcoding. In some implementations, transcoding is never performed for audio and video content. In other implementations, audio content is transformed only when a target device does not support the audio coding format. During the remuxing operations, meta-data is reconstructed (e.g., for the video and/or audio content).

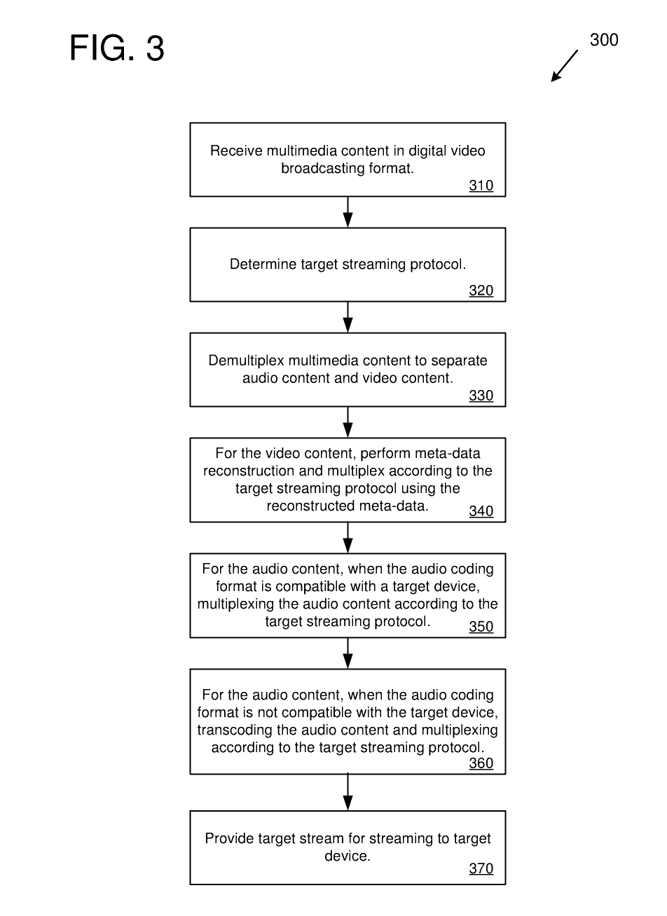

FIG. 3 is a flowchart of an example method 300 for remuxing multimedia content received in a DVB format (e.g., via an over-the-air digital video broadcast television signal, by a cable television signal, or by a satellite television signal). The example method 300 can be performed, at least in part, by a computing device, such as the computing device 110 described with reference to FIG. 1.

At 310, multimedia content (comprising audio content and video content) is received in a digital video broadcasting format. For example, the multimedia content can be encoded using one of a variety of audio codecs (e.g., AAC, AC-3, MP3, etc.) and video codecs (e.g., H.264, HEVC, etc.) within the digital video broadcasting format (e.g., using a digital television broadcast standard such as Digital Video Broadcasting-Terrestrial (DVB-T) or Advanced Television Systems Committee (ATSC) standards).

At 320, a target streaming protocol is determined. In some implementations, the target streaming protocol is pre-determined (e.g., HLS or DASH). In some implementations, the target streaming protocol is selected based on capabilities of the target computing device (or target computing devices) to which the remuxed multimedia content will be provided.

At 330, the received multimedia content is demultiplexed to separate the audio content and the video content.

At 340, meta-data reconstructions is performed for the video content and the video content is then multiplexed into a target stream according to the target streaming protocol using the reconstructed meta-data.

Meta-data reconstruction can involve a number of operations to determine missing meta-data. For example, meta-data reconstruction can be performed to determine meta-data including timing information (e.g., DTS and/or PTS information), picture type information (e.g., to identify pictures as I pictures, P pictures, B pictures, IDR pictures, etc.), discontinuity information, duration information, and/or frame size information.

Meta-data reconstruction can be used to reconstruct PTS and/or DTS information using header parsing. For example, results of header parsing (e.g., picture type information, picture ordering information, and/or inter-picture dependency information) can be used to determine missing and/or incomplete PTS and/or DTS information. PTS and/or DTS information can also be adjusted to compensate for detected discontinuities in the received video content.

Meta-data reconstruction can be used to identify IDR pictures. For example, header parsing can be performed and IDR pictures can be identified. The IDR pictures can then be identified in meta-data of the target stream according to the target streaming protocol. For example, some target streaming protocols (e.g., HLS and DASH) require that IDR pictures be identified in the meta-data. Because identification of IDR pictures may be missing in the received multimedia content, it can be determined and added to the target stream meta-data.

Meta-data reconstruction can be used to determine duration information. Duration information refers to the duration of a video frame. For example, if the video content has a frame rate of 30 frames per second (FPS), the duration of a given frame can be determined to be 33.3 ms. In some implementations, duration information is missing from the received multimedia content and is therefore determined and added for each picture in the remuxed target stream.

Meta-data reconstruction can be used to determine frame size information. Frame size refers to the number of bytes of a compressed frame (also called a picture boundary). In some implementations, frame size information is missing from the received multimedia content and is therefore determined and added for each picture in the remuxed target stream.

At 350, when the audio coding format is compatible with a target device (or multiple target devices), the audio content is multiplexed into the target stream according to the target streaming protocol. In some implementations, a header format of the audio content is changed, such as changing from AAC in the LATM format to AAC in the ADTS format. Changing the header formatting of the audio content can be performed based on capabilities of the target device.

At 360, when the audio coding format is not compatible with the target device (or the target devices), the audio content is transcoded before being multiplexed into the target stream according to the target streaming protocol. For example, the audio content can be transcoded from AC-3 to AAC.

At 370, the target stream (formatted according to the target streaming protocol) is provided for streaming to the target device (or to multiple target devices). For example, the target stream can be saved for later streaming or provided for immediate streaming as multimedia content is remuxed.

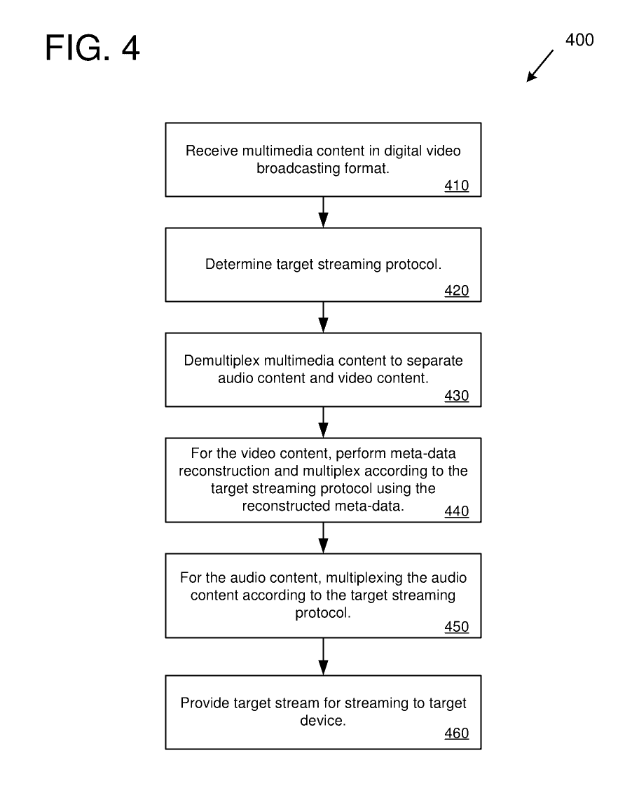

FIG. 4 is a flowchart of an example method 400 for remuxing multimedia content received in a DVB format (e.g., via an over-the-air digital video broadcast television signal, by a cable television signal, or by a satellite television signal). The example method 400 can be performed, at least in part, by a computing device, such as the computing device 110 described with reference to FIG. 1.

At 410, multimedia content (comprising audio content and video content) is received in a digital video broadcasting format. For example, the multimedia content can be encoded using one of a variety of audio codecs (e.g., AAC, AC-3, MP3, etc.) and video codecs (e.g., H.264, HEVC, etc.) within the digital video broadcasting format.

At 420, a target streaming protocol is determined. In some implementations, the target streaming protocol is pre-determined (e.g., HLS or DASH). In some implementations, the target streaming protocol is selected based on capabilities of the target computing device (or target computing devices) to which the remuxed multimedia content will be provided.

At 430, the received multimedia content is demultiplexed to separate the audio content and the video content.

At 440, meta-data reconstructions is performed for the video content and the video content is then multiplexed into a target stream according to the target streaming protocol using the reconstructed meta-data.

At 450, the audio content is multiplexed into the target stream according to the target streaming protocol. In some implementations, a header format of the audio content is changed, such as changing from AAC in the LATM format to AAC in the ADTS format. Changing the header formatting of the audio content can be performed based on capabilities of the target device. In some implementations, the audio is transcoded (e.g., if it is not compatible with a target computing device or if it is received in an audio coding format that is not supported by the target streaming protocol).

At 460, the target stream (formatted according to the target streaming protocol) is provided for streaming to the target device (or to multiple target devices). For example, the target stream can be saved for later streaming or provided for immediate streaming as multimedia content is remuxed.

The example methods 300 and 400 can be performed in real-time or “on-the-fly” as the multimedia content is being received. In this situation, there may only be a small delay (e.g., a few seconds) between video content as it is received, remuxed, and streamed to the target computing device for decoding and display. For example, a user may access an entertainment device (e.g., a set-top-box or gaming console connected to a television) and select an over-the-air television channel via a digital television tuner. The user may then select a user interface option to stream the content (e.g., a movie or television show) shown in the television channel to the user's computing device (e.g., the user's phone or tablet). The example methods 300 and 400 can be performed to stream the content in real-time to the user's computing device for display (e.g., while the user uses the television to play a video game).

The example methods 300 and 400 can be used to remux multimedia content received in a digital video broadcasting format into a target streaming protocol format without loss of quality of the audio and/or video content. In this way, the original quality of the content received via the digital television broadcast can be retained and streamed to other computing devices.

### Computing Systems

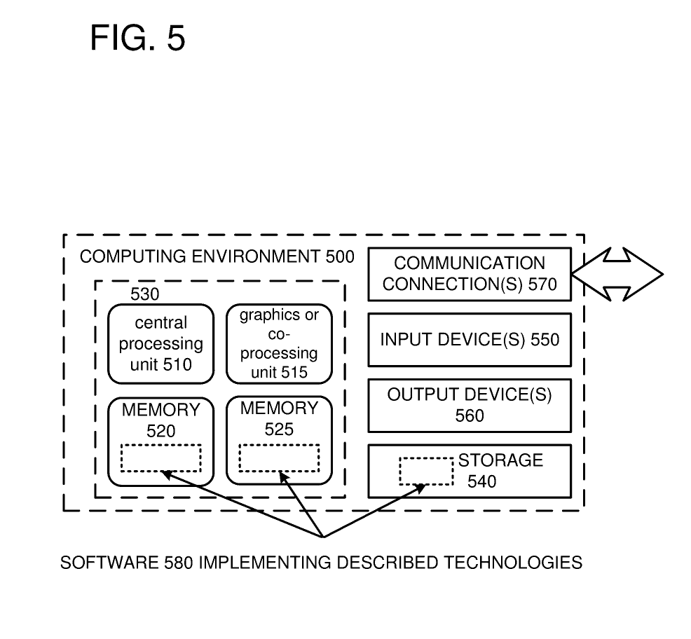

FIG. 5 depicts a generalized example of a suitable computing system 500 in which the described innovations may be implemented. The computing system 500 is not intended to suggest any limitation as to scope of use or functionality, as the innovations may be implemented in diverse general-purpose or special-purpose computing systems.

With reference to FIG. 5, the computing system 500 includes one or more processing units 510, 515 and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), non-volatile memory (e.g., ROM, EEPROM, flash memory, etc.), or some combination of the two, accessible by the processing unit(s). The memory 520, 525 stores software 580 implementing one or more innovations described herein, in the form of computer-executable instructions suitable for execution by the processing unit(s).

A computing system may have additional features. For example, the computing system 500 includes storage 540, one or more input devices 550, one or more output devices 560, and one or more communication connections 570. An interconnection mechanism (not shown) such as a bus, controller, or network interconnects the components of the computing system 500. Typically, operating system software (not shown) provides an operating environment for other software executing in the computing system 500, and coordinates activities of the components of the computing system 500.

The tangible storage 540 may be removable or non-removable, and includes magnetic disks, magnetic tapes or cassettes, CD-ROMs, DVDs, or any other medium which can be used to store information and which can be accessed within the computing system 500. The storage 540 stores instructions for the software 580 implementing one or more innovations described herein.

The input device(s) 550 may be a touch input device such as a keyboard, mouse, pen, or trackball, a voice input device, a scanning device, or another device that provides input to the computing system 500. For video encoding, the input device(s) 550 may be a camera, video card, TV tuner card, or similar device that accepts video input in analog or digital form, or a CD-ROM or CD-RW that reads video samples into the computing system 500. The output device(s) 560 may be a display, printer, speaker, CD-writer, or another device that provides output from the computing system 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Mobile Device

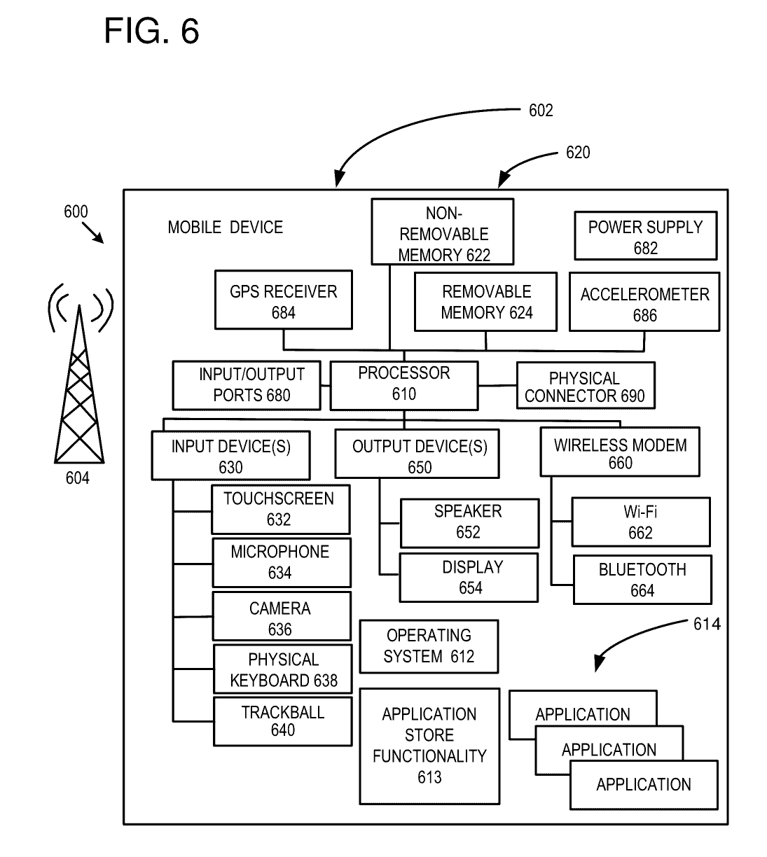

FIG. 6 is a system diagram depicting an example mobile device 600 including a variety of optional hardware and software components, shown generally at 602. Any components 602 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 604, such as a cellular, satellite, or other network.

The illustrated mobile device 600 can include a controller or processor 610 (e.g., signal processor, microprocessor, ASIC, or other control and processing logic circuitry) for performing such tasks as signal coding, data processing, input/output processing, power control, and/or other functions. An operating system 612 can control the allocation and usage of the components 602 and support for one or more application programs 614. The application programs can include common mobile computing applications (e.g., email applications, calendars, contact managers, web browsers, messaging applications), or any other computing application. Functionality 613 for accessing an application store can also be used for acquiring and updating application programs 614.

The illustrated mobile device 600 can include memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory or a Subscriber Identity Module (SIM) card, which is well known in GSM communication systems, or other well-known memory storage technologies, such as “smart cards.” The memory 620 can be used for storing data and/or code for running the operating system 612 and the applications 614. Example data can include web pages, text, images, sound files, video data, or other data sets to be sent to and/or received from one or more network servers or other devices via one or more wired or wireless networks. The memory 620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 600 can support one or more input devices 630, such as a touchscreen 632, microphone 634, camera 636, physical keyboard 638 and/or trackball 640 and one or more output devices 650, such as a speaker 652 and a display 654. Other possible output devices (not shown) can include piezoelectric or other haptic output devices. Some devices can serve more than one input/output function. For example, touchscreen 632 and display 654 can be combined in a single input/output device.

The input devices 630 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 can comprise speech-recognition software as part of a voice user interface that allows a user to operate the device 600 via voice commands. Further, the device 600 can comprise input devices and software that allows for user interaction via a user's spatial gestures, such as detecting and interpreting gestures to provide input to a gaming application.

A wireless modem 660 can be coupled to an antenna (not shown) and can support two-way communications between the processor 610 and external devices, as is well understood in the art. The modem 660 is shown generically and can include a cellular modem for communicating with the mobile communication network 604 and/or other radio-based modems (e.g., Bluetooth 664 or Wi-Fi 662). The wireless modem 660 is typically configured for communication with one or more cellular networks, such as a GSM network for data and voice communications within a single cellular network, between cellular networks, or between the mobile device and a public switched telephone network (PSTN).

The mobile device can further include at least one input/output port 680, a power supply 682, a satellite navigation system receiver 684, such as a Global Positioning System (GPS) receiver, an accelerometer 686, and/or a physical connector 690, which can be a USB port, IEEE 1394 (FireWire) port, and/or RS-232 port. The illustrated components 602 are not required or all-inclusive, as any components can be deleted and other components can be added.

### Cloud-Supported Environment

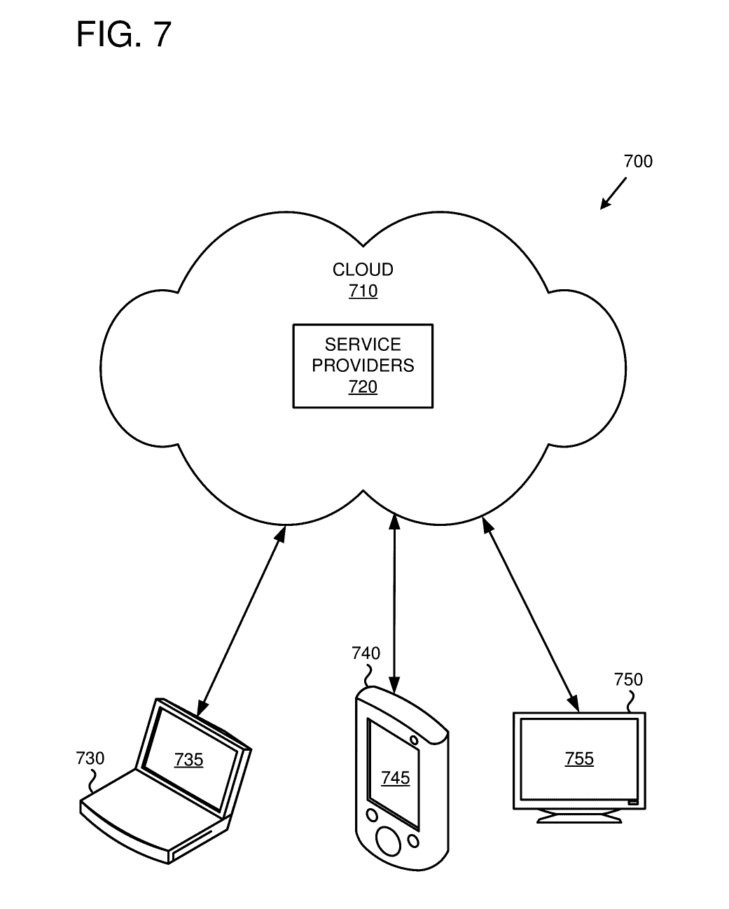

FIG. 7 illustrates a generalized example of a suitable cloud-supported environment 700 in which described embodiments, techniques, and technologies may be implemented. In the example environment 700, various types of services (e.g., computing services) are provided by a cloud 710. For example, the cloud 710 can comprise a collection of computing devices, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730, 740, 750) while other tasks (e.g., storage of data to be used in subsequent processing) can be performed in the cloud 710.

In example environment 700, the cloud 710 provides services for connected devices 730, 740, 750 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, and the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touchscreen capability of a particular connected device (e.g., connected devices 730, 740, 750).

In example environment 700, the cloud 710 provides the technologies and solutions described herein to the various connected devices 730, 740, 750 using, at least in part, the service providers 720. For example, the service providers 720 can provide a centralized solution for various cloud-based services. The service providers 720 can manage service subscriptions for users and/or devices (e.g., for the connected devices 730, 740, 750 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 5, computer-readable storage media include memory 520 and 525, and storage 540. By way of example and with reference to FIG. 6, computer-readable storage media include memory and storage 620, 622, and 624. The term computer-readable storage media does not include signals and carrier waves. In addition, the term computer-readable storage media does not include communication connections (e.g., 570, 660, 662, and 664).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Pert, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A computing device comprising:
a processing unit;
memory; and
an antenna configured for receiving digital video broadcast television signals;
the processing unit configured to perform operations for remuxing multimedia content, the operations comprising:
receiving, via the antenna, the multimedia content in a digital video broadcasting format, the multimedia content comprising audio content and video content;
determining a target streaming protocol;
demultiplexing the multimedia content in the digital video broadcasting format to separate the audio content and the video content;
for the video content:
performing meta-data reconstruction for the video content based, at least in part, on the target streaming protocol; and
multiplexing the video content in a target stream according to the target streaming protocol using the reconstructed meta-data and without transcoding the video content;
for the audio content:
when an audio coding format of the audio content is compatible with a target computing device, multiplexing the audio content in the target stream according to the target streaming protocol without transcoding the audio content; and
otherwise, when the audio coding format of the audio content is not compatible with the target computing device, transcoding the audio content to a different audio coding format for multiplexing in the target stream according to the target streaming protocol; and
providing the target stream according to the target streaming protocol for streaming to the target computing device.

2. The computing device of claim 1 wherein the performing meta-data reconstruction for the video content comprises:
performing header parsing of the video content to reconstruct timing information comprising one or more of: presentation timestamp (PTS) information and decoding timestamp (DTS) information.

3. The computing device of claim 1 wherein the performing meta-data reconstruction for the video content comprises:
performing header parsing of the video content to determine:
picture types for pictures of the video content; and
picture ordering for the pictures of the video content; and
reconstruct timing information, comprising:
determining a starting decoding timestamp (DTS) value from a minimum presentation timestamp (PTS) value;
calculating a DTS offset value; and
adjusting the starting DTS value by subtracting the DTS offset value.

4. The computing device of claim 1 wherein the performing meta-data reconstruction for the video content comprises:
performing header parsing of the video content to determine instantaneous decoding refresh (IDR) pictures of the video content; and
including information identifying the IDR pictures in the reconstructed meta-data.

5. The computing device of claim 1 wherein the performing meta-data reconstruction for the video content comprises:
performing header parsing of the video content to determine a frame rate; and
based on the frame rate, adding picture duration information to the reconstructed meta-data.

6. The computing device of claim 1 wherein the performing meta-data reconstruction for the video content comprises:
performing header parsing of the video content to determine a frame size; and
incorporating the frame size into the reconstructed meta-data.

7. The computing device of claim 1 wherein the antenna is configured as a digital television tuner module connected to the computing device via a universal serial bus interface.

8. The computing device of claim 1 wherein the target streaming protocol is one of HTTP Live Streaming (HLS) and Dynamic Adaptive Streaming over HTTP (DASH).

9. A method for remuxing multimedia content, the method comprising:
receiving multimedia content in a digital video broadcasting format, the multimedia content comprising audio content and video content;
determining a target streaming protocol;
demultiplexing the multimedia content in the digital video broadcasting format to separate the audio content and the video content;
for the video content:
performing meta-data reconstruction for the video content based, at least in part, on the target streaming protocol; and
multiplexing the video content in a target stream according to the target streaming protocol using the reconstructed meta-data and without transcoding the video content;
for the audio content:
multiplexing the audio content in the target stream according to the target streaming protocol without transcoding the audio content; and
providing the target stream according to the target streaming protocol for streaming to the target computing device.

10. The method of claim 9 wherein the audio content is multiplexed without transcoding an audio coding format of the audio content when the audio coding format is compatible with a target computing device, the method further comprising:
when the audio coding format of the audio content is not compatible with the target computing device, transcoding the audio content to a different audio coding format for multiplexing in the target stream according to the target streaming protocol.

11. The method of claim 9 further comprising, for the audio content:
for Advanced Audio Coding (AAC) audio content, changing an audio transport stream format of the audio content from Low Overhead Audio Transport Multiplex (LATM) to Audio Data Transport Stream (ADTS).

12. The method of claim 9 wherein the performing meta-data reconstruction for the video content comprises:
performing header parsing of the video content to reconstruct timing information comprising one or more of: presentation timestamp (PTS) information and decoding timestamp (DTS) information.

13. The method of claim 9 wherein the performing meta-data reconstruction for the video content comprises:
performing header parsing of the video content to determine:
picture types for pictures of the video content; and
picture ordering for the pictures of the video content; and
reconstruct timing information, comprising one or more of presentation timestamp (PTS) information and decoding timestamp (DTS) information, for each picture of the video content based at least in part on the picture types and the picture ordering.

14. The method of claim 9 wherein the performing meta-data reconstruction for the video content comprises:
performing header parsing of the video content to determine instantaneous decoding refresh (IDR) pictures of the video content; and
including information identifying the IDR pictures in the reconstructed meta-data.

15. The method of claim 9 wherein the target streaming protocol is one of HTTP Live Streaming (HLS) and Dynamic Adaptive Streaming over HTTP (DASH).

16. A computer-readable storage medium storing computer-executable instructions for causing a computing device to perform operations for remuxing multimedia content, the operations comprising:
receiving multimedia content in a digital video broadcasting format, the multimedia content comprising audio content and video content;
determining a target streaming protocol;
demultiplexing the multimedia content in the digital video broadcasting format to separate the audio content and the video content;
for the video content:
performing meta-data reconstruction for the video content based, at least in part, on the target streaming protocol; and
multiplexing the video content in a target stream according to the target streaming protocol using the reconstructed meta-data and without transcoding the video content;
for the audio content:
multiplexing the audio content in the target stream according to the target streaming protocol without transcoding the audio content; and
providing the target stream according to the target streaming protocol for streaming to the target computing device.

17. The computer-readable storage medium of claim 16 wherein the audio content is multiplexed without transcoding an audio coding format of the audio content when the audio coding format is compatible with a target computing device, the method further comprising:
when the audio coding format of the audio content is not compatible with the target computing device, transcoding the audio content to a different audio coding format for multiplexing in the target stream according to the target streaming protocol.

18. The computer-readable storage medium of claim 16 wherein the performing meta-data reconstruction for the video content comprises:
performing header parsing of the video content to reconstruct timing information comprising one or more of: presentation timestamp (PTS) information and decoding timestamp (DTS) information.

19. The computer-readable storage medium of claim 16 wherein the performing meta-data reconstruction for the video content comprises:
performing header parsing of the video content to determine:
picture types for pictures of the video content; and
picture ordering for the pictures of the video content; and
reconstruct timing information, comprising one or more of presentation timestamp (PTS) information and decoding timestamp (DTS) information, for each picture of the video content based at least in part on the picture types and the picture ordering.

20. The computer-readable storage medium of claim 16 wherein the performing meta-data reconstruction for the video content comprises:
performing header parsing of the video content to determine instantaneous decoding refresh (IDR) pictures of the video content; and
including information identifying the IDR pictures in the reconstructed meta-data.
